(19) United States
(12) Patent Application Publication
(10) Pub. No.: US 2023/0098545 A1
(43) Pub. Date: Mar. 30, 2023

(54) SADDLE BOTTOM STORAGE TANK

(71) Applicant: FOREMOST UNIVERSAL LP BY ITS GENERAL PARTNER, UNIVERSAL INDUSTRIES (FOREMOST) CO., Lloydminster (CA)

(72) Inventor: John KLUMPENHOUWER, Edmonton (CA)

(21) Appl. No.: 17/956,526

(22) Filed: Sep. 29, 2022

Related U.S. Application Data
(60) Provisional application No. 63/250,752, filed on Sep. 30, 2021.

(51) Int. Cl. B65D 90/08

(52) U.S. Cl. CPC B65D 90/08

(57) ABSTRACT

A storage tank includes an upper tank having a cylindrical shape and a lower circumferential edge having a contoured shape. A top surface of a tank floor body is in sealing contact with the lower circumferential edge and conforms to the contoured shape. The tank floor body has a saddle shape. An upper cap is joined to an upper circumferential edge of the upper tank. The upper cylindrical tank shell, the tank floor body, and the upper cap form an inner storage volume. The storage tank may also include a lower skirt having a cylindrical shape and an upper circumferential edge having the contoured shape. A bottom surface of the tank body floor is joined to the upper circumferential edge and the lower tank skirt, and the upper tank share a common central axis.

### CROSS REFERENCE TO RELATED APPLICATIONS

This application claims the benefit of priority to U.S. Provisional Patent Application Ser. No. 63/250,752 filed on Sep. 30, 2021, the contents of which are incorporated by reference.

### FIELD OF THE INVENTION

The present invention pertains to the field of storage tanks and in particular to petroleum storage tanks where the contents may be stored under pressure.

### BACKGROUND

Pressure vessels can theoretically be almost any shape, but shapes composed of spheres or cylinders are usually employed. In the case where the vessel is composed of a mainly cylindrical shape, spheres, cylinders, or cones are often used to at the ends.

There are several kinds of storage tanks generally employed in the petroleum industry for storing volatile liquids such as gasoline and liquefied petroleum gases (LPG). These tanks must be designed to withstand internal pressures and include the Atmospheric Storage Tank and the Low Pressure Storage tank. The construction code published by the American Petroleum Institute for the atmospheric storage tank is API STD 650, and for a low pressure storage tank is API STD 620. These cover the minimum requirements for design, materials, fabrication, inspection, and testing. The standards specify maximum pressures for vapor or gas space of the storage tanks. For an atmospheric storage tank, the maximum pressure is 2.5 pounds per square inch gauge (psig), and for a low pressure storage tank the maximum pressure is 15 psig. If the pressure in the vapor or gas space of the storage tank is more than 15 psig, the liquid cannot be stored in the storage tank, and it is necessary to be stored in a pressure vessel.

Pressure vessels can theoretically be almost any shape, but shapes made of sections of spheres, cylinders, and cones are usually employed. Theoretically, a sphere would be the best shape of a pressure vessel, due to the even distribution of stresses on the sphere's surfaces, both internally and externally, generally means that there are no weak points. Spheres, however, are much more costly to manufacture than cylindrical vessels.

Cylinders are widely used for storage due to their being less expensive to produce than spheres. However, cylinders are not as strong as spheres due to the weak point at each end. A common design for reducing weakness at the ends of the pressurized storage vessels is to provide the cylinder with hemispherical, rounded or dished (torispherical) end caps called heads. Cylindrical pressure vessels are commonly provided with 2:1 semi-elliptical heads or end caps on each end. Due to the ellipsoidal head design, pressure storage tanks are typically horizontal tanks, which are expensive to design, and have long lead times.

When designing storage tanks suitable for storing petroleum products at higher pressures, standard low pressure tank design codes (i.e., tanks suitable for storage at less than 15 psig) do not provide good solutions that can be applied to the design of pressurised tanks. For example, such a design typically requires incorporating a cone bottom into the storage tank, which is expensive and requires the loss of tank volume. They can require structural reinforcements for supporting a cone bottomed tank in place, which can be very labour intensive and may cause later operation issues with the tank.

The industry is therefore looking for a cost effective solution that provides storage tanks suitable for storing petroleum products at higher pressures, without incurring the higher design and maintenance costs associated with pressure vessels, and which do not suffer from the deficiencies associated with standard modifications to low pressure tank designs to accommodate higher pressure contents.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a saddle storage tank. In accordance with an aspect of the present invention, there is provided a storage tank including an upper tank having a cylindrical shape and a lower circumferential edge having a contoured shape. A top surface of a tank floor body is in sealing contact with the lower circumferential edge and conforms to the contoured shape where the tank floor body has a saddle shape. An upper cap is joined to an upper circumferential edge of the upper tank. The upper cylindrical tank shell, the tank floor body, and the upper cap form an inner storage volume.

Further embodiments include a lower skirt having a cylindrical shape and an upper circumferential edge having the contoured shape. A bottom surface of the tank body floor is joined to the upper circumferential edge, and the lower tank skirt and the upper tank share a common central axis.

In further embodiments, the contoured shape is formed by the intersection of a virtual horizontal cylinder with the cylindrical shape.

In further embodiments, the virtual horizontal cylinder has a larger diameter than a diameter of the cylindrical shape and the tank floor body extends outwards around the contoured shape.

In further embodiments, the intersection of the virtual horizontal cylinder with the cylindrical shape intersects perpendicularly.

In further embodiments, the intersection of the virtual horizontal cylinder with the cylindrical shape intersects at an angle greater or less than 90 degrees.

In further embodiments, the virtual horizontal cylinder is an elliptical prism.

In further embodiments, the virtual horizontal cylinder has a surface created by intersecting a polynomial or a sinusoidal curve with the cylindrical shape.

In further embodiments, the upper tank and the lower skirt are formed from a single metal sheet that has been cut to form the contoured shape.

In further embodiments, the top surface of the tank floor body and the lower circumferential edge are sealed by welding, and the bottom surface of the tank body floor and the upper circumferential edge are joined by welding.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

FIG. 1 illustrates a perspective view of a storage tank in accordance with an embodiment.

FIG. 2 illustrates a perspective view of a storage tank showing the bottom cap in accordance with an embodiment.

FIG. 3 illustrates a side view of a storage tank in accordance with an embodiment.

FIG. 4 illustrates an alternate side view of a storage tank in accordance with an embodiment.

FIG. 5 includes a diagram on how a floor body of a storage tank may be determined in accordance with an embodiment.

FIG. 6 includes a diagram of how a floor body may be manufactured to extend beyond a storage tank in accordance with an embodiment.

FIG. 7 illustrates a perspective view of an isolated bottom floor body in accordance with an embodiment.

FIG. 8 illustrates an unrolled storage tank side of a first pattern in accordance with an embodiment.

FIG. 9 illustrates an unrolled storage tank side of a second pattern in accordance with an embodiment.

It will be noted that throughout the appended drawings, like features are identified by like reference numerals.

### DETAILED DESCRIPTION OF THE INVENTION

Embodiments of the invention will now be described with reference to specific examples. It will be understood that the following examples are intended to describe embodiments of the invention and are not intended to limit the invention in any way. Unless defined otherwise, all technical and scientific terms used herein have the same meaning as commonly understood by one of ordinary skill in the art to which this invention belongs.

Embodiments of the present invention provide a storage tank design with a saddle-like contoured bottom that provides strength to the storage tank and allows for operation at higher pressures than most atmospheric tanks, without the associated problems of cone bottoms or structurally reinforced tanks. Embodiments include a cylinder that is cut in a wave pattern to form a top tank portion and a bottom base portion. A flat sheet of metal is fixed to form a cap on the bottom end of the top portion and assumes a saddle shape. The bottom base portion may then be fixed to a bottom surface of the saddle shaped bottom cap to support the assembled storage tank. The saddle shape is more resistant to pressure that a flat plate and allows the tank to operate up to 15 psig without the use of a cone cap, steel reinforcement, or anchor chairs to hold it down. The unique bottom to shell joint also provides reinforcement to the tank to ensure that it keeps its shape and is structurally sound.

Embodiments may be used for the storage of petroleum products. The term “petroleum product” is used to refer to products of the petroleum industry, including but not limited to crude oil, and materials derived from crude oil, such as gas oils, furnace oils, naphtha, gasoline, light crude oil, kerosene, jet fuel, diesel fuel, gasoline blending stocks, light naphtha, pentane, water, and mixtures thereof.

Embodiments provide a cost effective solution to for oil and gas storage tanks at higher pressures, without having to design and pay for a pressure vessel. Pressure Vessels are more expensive and require yearly inspections and associated fees. Standard storage tank design codes (less than 15 psig) do not have great standard solutions for pressurised tanks. They typically require cone bottoms which are expensive and require the loss of a lot of tank volume, or they require structural reinforcement with is very labour intensive and can cause operation issues with the tank.

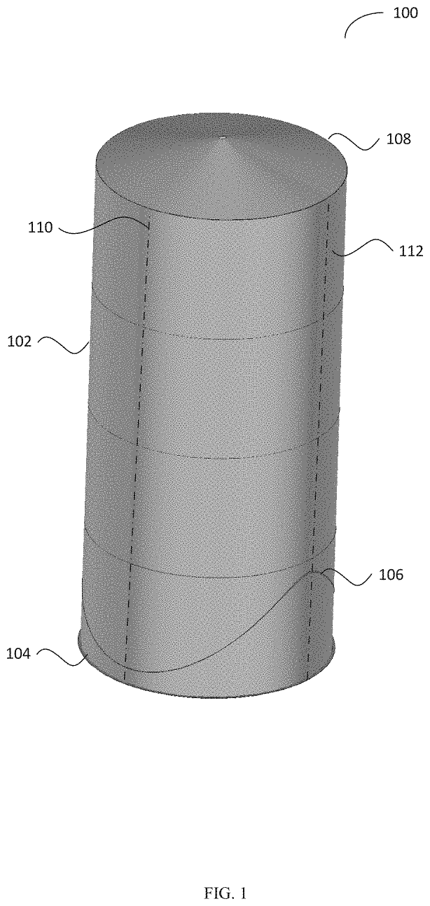

FIG. 1 illustrates a perspective view of a storage tank 100 in accordance with an embodiment. In accordance with the present invention, a storage tank 100 is provided that comprises a storage volume formed from an upper tank 102 welded to a tank floor body 106 having a saddle shape. The storage volume may be completed by an upper cap 108 that covers or seals the upper portion of the storage tank 100. The upper tank 102 has a lower circumferential shell edge having a contoured shape that conforms to the saddle shape of the floor body 106. The storage tank 100 may also comprises a lower skirt 104 welded to a lower face of the tank floor 106 so that the upper tank 102 and the lower skirt 104 share a common central axis and the lower skirt 104 provides a support base for the storage tank 100. Lower skirt 104 may provide reinforcement to the storage tank 100 to aid it in keeping its shape and be structurally sound. In embodiments where the lower skirt 104 is not used, alternative supports may be supplied to support the storage tank 100. The upper circumferential shell edge of the lower skirt has a contoured shape that conforms to the saddle shape of the tank floor 106. Upper cap 108 may come in a variety of shapes including conical, semi spherical, tori spherical, etc.

In embodiments where lower skirt 104 is used, the space within lower skirt 104 (below tank floor 106, encloses an area under the fluid retaining portion of storage tank 100 that may be used to house valves, heaters, inspection openings, fuel gas scrubbers, and other associated tank components within a contained area to prevent spills outside the tank. The area enclosed by lower skirt 104 also provides and enclosure so that the fluid retained portion may not need to be insulated or protected from the environment.

A first longitudinal line 110 runs parallel to an axis of the storage tank 100 and intersects a low edge of the floor body 106. A second longitudinal line 112 runs parallel to an axis of the storage tank 100 and intersects an upper edge of the floor body 106.

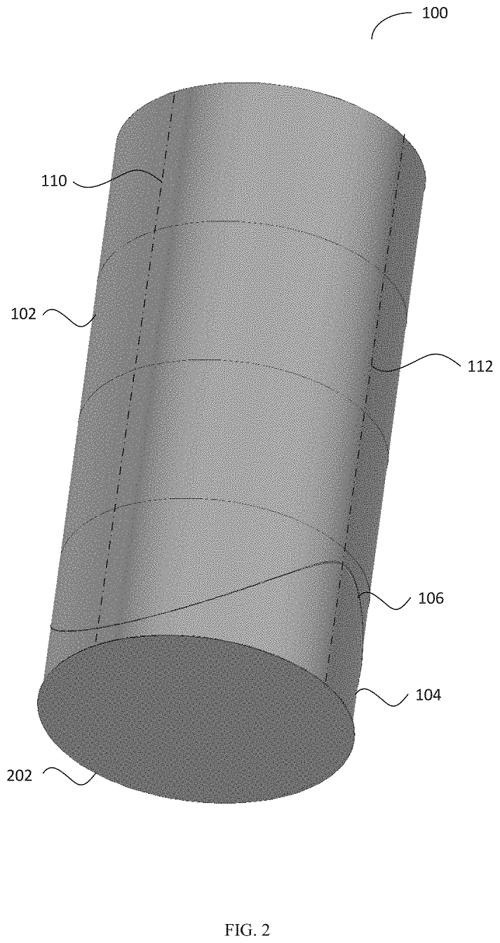

FIG. 2 illustrates a perspective view of a storage tank 100 showing the bottom cap in accordance with an embodiment. A bottom cap 202 is shown fixed to a bottom of lower skirt 104. In embodiments bottom cap 202 may be a flat metal sheet, a conical shape with its apex facing upwards, or bottom cap 202 may be omitted completely. Bottom cap 202 may serve the purpose of helping support storage tank 100 on a base, on the ground, or on another support structure or foundation.

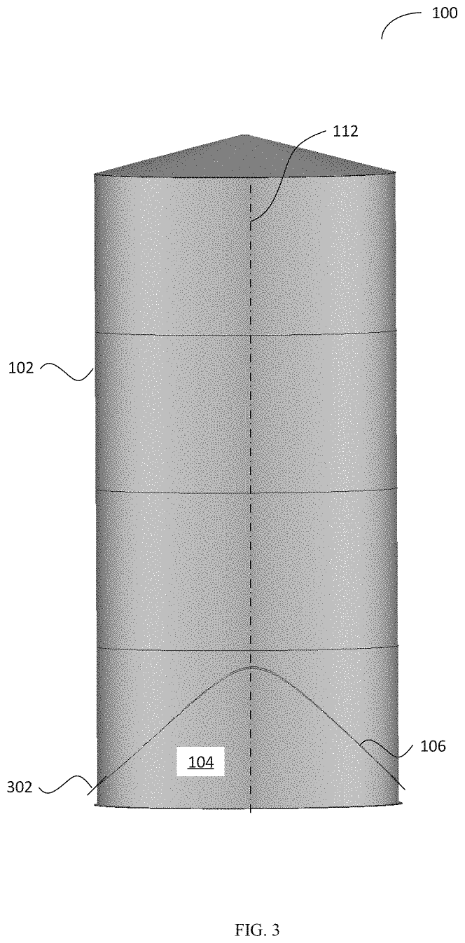

FIG. 3 illustrates a side view of a storage tank 100 in accordance with an embodiment. FIG. 3 illustrates how floor body 106 is has a high point along longitudinal line 112. In embodiments, an edge portion 302 of floor body 106 may extend beyond the outer edges of upper tank 102, lower skirt 104, or both upper tank 102 and lower skirt 104. Edge portion 302 may be formed around the full circumference or a partial circumference of upper tank 102 or lower skirt 104 in one or more location around the circumference. Edge portion 302 adds additional strength to storage tank 100 and can provide support to move or support storage tank 100. Edge portion 302 may also function as a fit up tool for attachment of the upper tank 102 or the lower skirt 104.

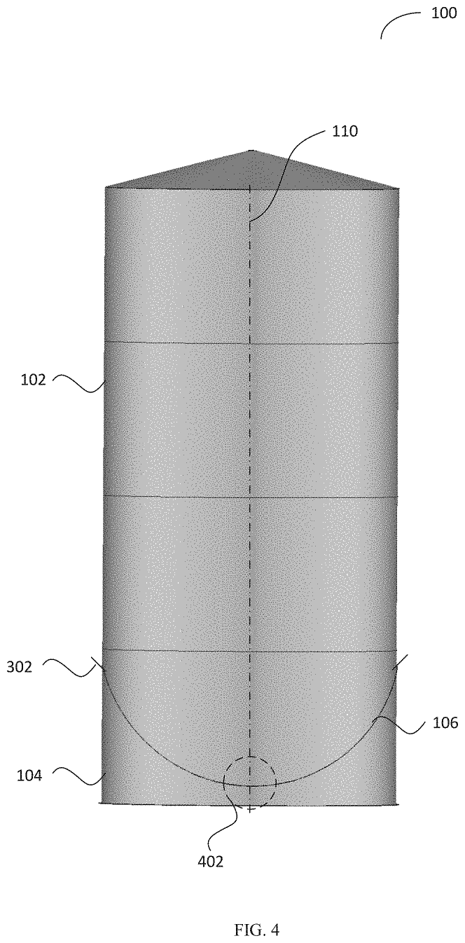

FIG. 4 illustrates an alternate side view of a storage tank 100 in accordance with an embodiment. FIG. 4 illustrates how floor body 106 is has a low point 402 along longitudinal line 110. Also visible is edge portion 302 which may extend beyond the outer edges of upper tank 102, lower skirt 104, or both upper tank 102 and lower skirt 104. The low point 402 of floor body 106 extends in a line across the diameter of storage tank 100 and acts as a beam that adds strength to storage tank 100 and helps it to keep its circular shape.

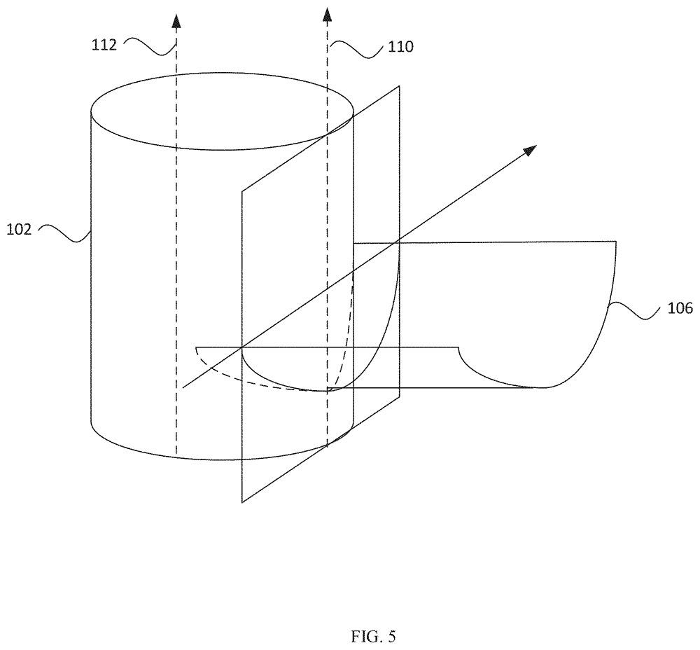

FIG. 5 includes a diagram on how a floor body 106 of a storage tank 100 may be determined in accordance with an embodiment. Upper tank 102 may be formed from a vertically oriented cylinder of a diameter d₁. Floor body 106 may be viewed as a truncated horizontally oriented cylinder, elliptic prism, or elliptic cylinder that intersects the cylinder of floor body 106. In embodiments, the truncated horizontally oriented cylinder intersects the cylinder of the floor body 106 perpendicularly. In embodiments, the truncated horizontally oriented cylinder intersects the cylinder of the floor body 106 at a slight angle to each other, such that the floor body 106 is slightly tilted to form a trough having a single low point at one edge.

In order for the horizontal cylinder to form a working floor body 106, the horizontal cylinder must have a diameter d₂, where d₁≤d₂. If d₂ is <d₁, then the floor body 106 may also include edge portion 302. The horizontal truncated cylinder used to form floor body 106 can also be at an angle along its longitudinal axis to the horizon so that a singular low point in the tank is created. In embodiments, upper tank 102 may have a diameter between 4 feet and 40 feet and storage tank 100 may have a height between 8 feet and 50 feet.

In embodiments, the cross section of floor body 106 may have a number of profiles or shapes. For example, the horizontal truncated cylinder used to form floor body 106 can also be a truncated elliptical prism to allow for a steeper angle inside the storage tank 100. Alternatively, the horizontal truncated cylinder may also be a surface created by intersecting a polynomial or sinusoidal curve with the vertical cylindrical tank to create a more complex fluid retaining surface at the bottom of the tank.

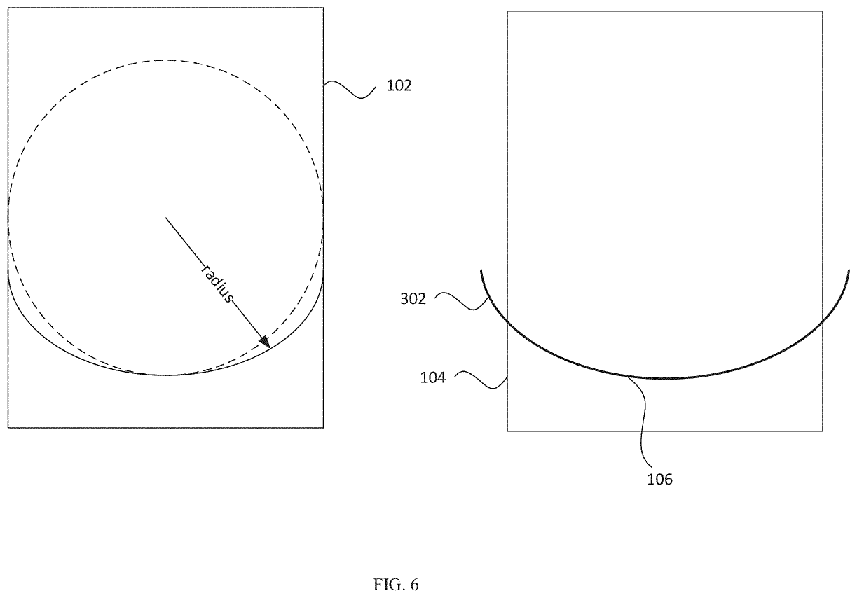

FIG. 6 includes a diagram of how a floor body 106 may be manufactured to extend beyond a storage tank 100 in accordance with an embodiment. As the diameter, d₂, of the horizontal truncated cylinder used to form floor body 106 is larger than d₁, or vertically oriented cylinder of upper tank 102, an edge portion 302 extends beyond the wall of upper tank 102. In embodiments edge portion 302 will protrude from the wall of upper tank 102 by 2 inches or more to be used effectively.

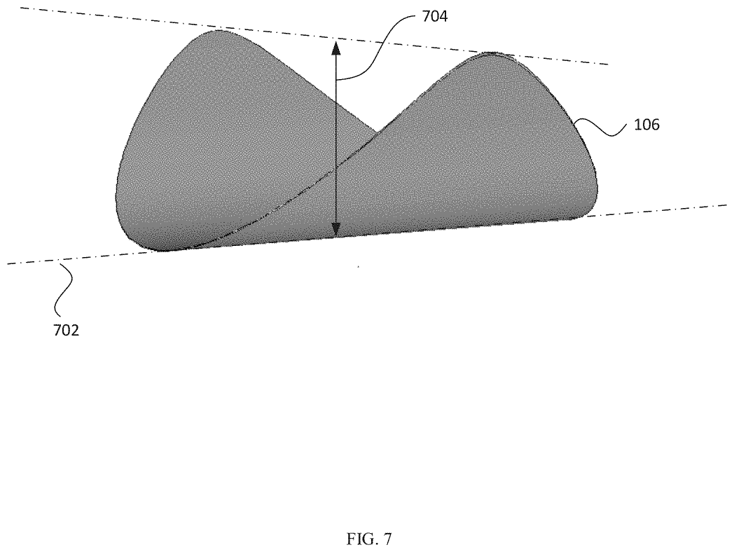

FIG. 7 illustrates a perspective view of an isolated bottom floor body 106 in accordance with an embodiment. Floor body 106 is formed based on the intersection of a vertical cylinder of upper tank 102 intersecting with a truncated horizontal cylinder or curved shape and has the shape of a saddle. If floor body 106 was to be flattened, it would form an elliptical shape. Floor body 106 includes a straight or substantially straight bottom line at or near the fold of the floor body 106 that may act as a trough or beam and support the sides of upper tank 102 to help it retain its shape in the assembled storage tank 100. Line 702 may be horizontal or be at an angle to allow for the contents of storage tank 100 to collect at one end of the bottom of storage tank 100. In embodiments, the beam formed at line 702 may have and angle between 0 degrees (horizontal) and 60 degrees. In embodiments, a vertical height of floor body 106 may be between 1 foot and 8 feet.

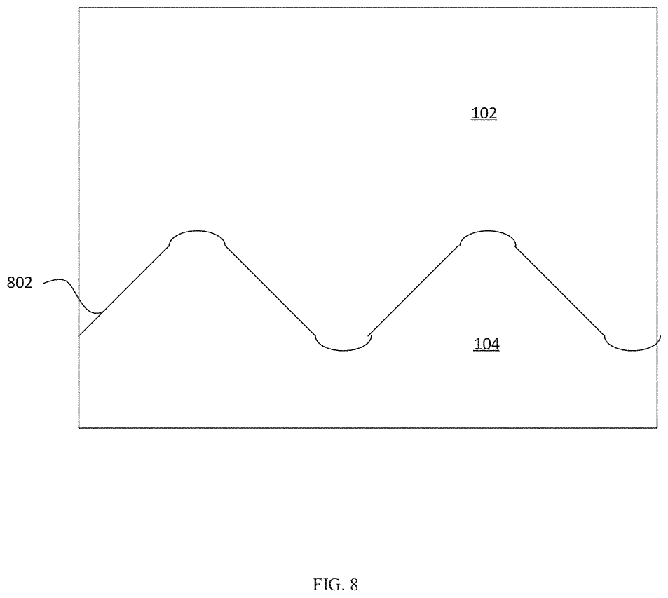

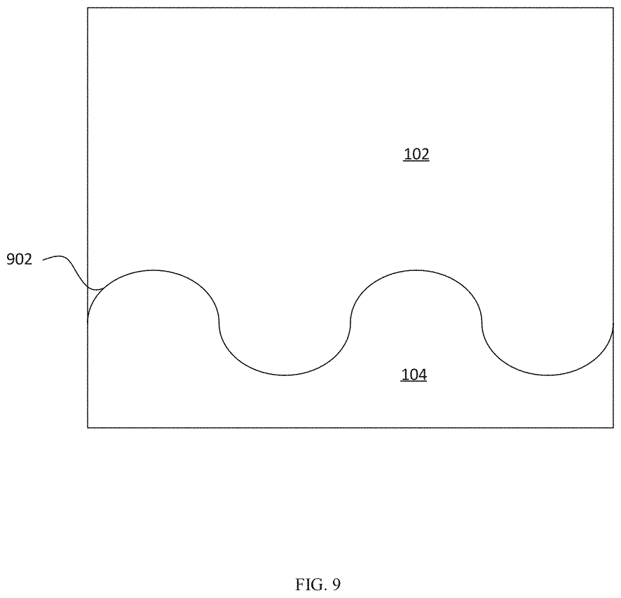

FIG. 8 illustrates an unrolled storage tank side of a first pattern in accordance with an embodiment. A method to manufacture storage tank 100 starts with a common sheet of suitable metal of a composition and thickness appropriate to the finished storage tank 100, to form upper tank 102 and lower skirt 104. The sheet metal may be cut along line 802 to separate the sheet metal into separate upper tank 102 and lower skirt 104, ensuring that both upper tank 102 and lower skirt 104 have the correct complementary shapes. Line 802 is made to match the desired saddle shape that floor body 106 should take in the assembled storage tank 100. FIG. 9 illustrates an alternative line 902 that may also be used. Variations on the line to cut in the sheet metal may be used to form the various possible shapes of floor body 106. Once the upper tank 102 and lower skirt 104 have been cut, they may be formed into a cylindrical shape and welded or otherwise fastened.

Floor body 106 may also be fashioned from a flat piece of sheet metal and cut to shape. Floor body 106 may then be forced onto the bottom edge of upper tank 102 and be fixed into place, for example, by welding, wherein the floor body 106 assumes the desired saddle shape. In embodiments, the material of floor body 106 is sufficiently flexible that gravity may be used to form it into the desired shape over either the upper tank 102 or the lower skirt 104. Floor body 106 may be cut larger than required in order to form edge portion 302 extending beyond the wall of upper tank 102. The floor body 106 of embodiments provides improvements over a conical cap of the prior art because it is easier to manufacture and does not require any special cutting, forming, or stiffening.

If used, lower skirt 104 may then be fixed, for example, by welding to the opposite surface of floor body 106. Finally, top cap 108 may be formed and attached to the upper end of upper tank 102. Alternatively, floor body 106 may be forced onto a top edge of lower skirt 104 wherein the floor body 106 assumes the desired saddle shape, and then upper tank 102 may be fixed to the upper surface of floor body 106.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

We claim:

1. A storage tank comprising:
an upper tank having a cylindrical shape and a lower circumferential edge having a contoured shape;
a top surface of a tank floor body in sealing contact with the lower circumferential edge and conforming to the contoured shape, the tank floor body having a saddle shape; and
an upper cap joined to an upper circumferential edge of the upper tank, the upper cylindrical tank shell, the tank floor body, and the upper cap forming an inner storage volume.

2. The storage tank of claim 1 further comprising a lower skirt having a cylindrical shape and an upper circumferential edge having the contoured shape, a bottom surface of the tank body floor joined to the upper circumferential edge, the lower tank skirt and the upper tank sharing a common central axis.

3. The storage tank of claim 1 wherein the contoured shape is formed by the intersection of a virtual horizontal cylinder with the cylindrical shape.

4. The storage tank of claim 3, wherein the virtual horizontal cylinder has a larger diameter than a diameter of the cylindrical shape, the tank floor body extending outwards around the contoured shape.

5. The storage tank of claim 3 wherein the intersection of the virtual horizontal cylinder with the cylindrical shape intersects perpendicularly.

6. The storage tank of claim 3 wherein the intersection of the virtual horizontal cylinder with the cylindrical shape intersects at an angle greater or less than 90 degrees.

7. The storage tank of claim 3 wherein the virtual horizontal cylinder is an elliptical prism.

8. The storage tank of claim 3 wherein the virtual horizontal cylinder has a surface created by intersecting a polynomial or a sinusoidal curve with the cylindrical shape.

9. The storage tank of claim 2 wherein the upper tank and the lower skirt are formed from a single metal sheet that has been cut to form the contoured shape.

10. The storage tank of claim 2 wherein the top surface of the tank floor body and the lower circumferential edge are sealed by welding, and the bottom surface of the tank body floor and the upper circumferential edge are joined by welding.
